(19) United States
(12) Patent Application Publication
(10) Pub. No.: US 2015/0229057 A1
(43) Pub. Date: Aug. 13, 2015

(54) ELECTRICAL CONNECTOR WITH ONE-PIECE TERMINALS

(71) Applicant: Advanced-Connectek Inc., New Taipei City (TW)

(72) Inventors: Ping-Chuan CHU, New Taipei City (TW); Xiao-Juan QI, New Taipei City (TW); Shu-Lin DUAN, New Taipei City (TW); Ching-Tien CHEN, New Taipei City (TW); Wei WAN, New Taipei City (TW)

(73) Assignee: Advanced-Connectek Inc.

(21) Appl. No.: 14/597,348

(22) Filed: Jan. 15, 2015

(30) Foreign Application Priority Data
Feb. 10, 2014 (CN) 201410046155.9

(51) Int. Cl. H01R 13/24

(52) U.S. Cl. CPC H01R 13/2428

(57) ABSTRACT

An electrical connector has an insulative body and multiple terminals. The insulative body has multiple mounting holes and multiple guiding channels. The terminals are mounted respectively the mounting holes and each terminal has an electrically contacting portion mounted slidably in one of the guiding channels. The guiding channels guides and ensures a corresponding electrically contacting portion to move linearly without being inadvertently jammed or irrecoverably deformed. Therefore, the life-span of the electrical connector is increased.

### BACKGROUND OF THE INVENTION

1. Field of the Invention

The present invention relates to a connector, and more particularly to an electrical connector that has multiple one-piece terminals. Each one-piece terminal has excellent resilience to provide stable extension and retraction functions. Furthermore, the one-piece terminal is capable of linearly extending or retracting instead of extending or retracting along a non-linearly and irregularly path, which prevents the one-piece terminal from being deformed or damaged.

2. Description of Related Art

Electrical connectors are commonly used electrical components in electronic devices and allow the electronic device to connect to another one to implement signal transmission or power supply between the connected electronic devices.

A conventional portable electronic device such as a smart phone usually has a battery chamber and a spring-type battery connector. The spring-type battery connector, as disclosed in the TW patent publication No. 201332225, TW patent No. M418465 or TW patent No. M462453, is mounted in the battery chamber and has an insulative body and multiple terminal assemblies mounted in the insulative body. Each terminal assembly has a soldering terminal, a contacting terminal and a spring. The contacting terminal is bullet-like and able to contact a pad contact of a battery. The spring is mounted between the soldering terminal and the contacting terminal and presses against the contacting terminal to extend out of the insulative body. However, the terminal assembly with multiple components is complicated in structure and fabrication. Inadvertent dislocation between adjacent components easily occurs and causes the contacting terminal to be jammed and not able to extend or retract. Furthermore, when large current are transmitted through the terminal assemblies, the terminal assemblies are overheated and the battery connector fails due to an insufficient contacting area between adjacent two of the soldering terminal, the spring and the contacting terminal.

With reference to FIG. 7, TW utility model patent No. M346937 discloses a connector with one-piece terminals. The connector has an insulative body 70, a shell 80 and multiple terminals 90. The shell 80 covers the insulative body 70. The insulative body 70 has multiple mounting holes 71 defined therein. The terminals 90 are formed into one piece and are mounted respectively in the mounting holes 71 of the insulative body 70. Each terminal 90 has a soldering portion 91, a spring portion 92 and a contacting portion 93. The spring portion 92 is horizontally zigzag, is formed on and protrudes from the soldering portion 91, and has a connecting section 921 and two resilient sections 922. The connecting section 921 is parallel to an axial direction of the terminal 90. The resilient sections 922 are connected respectively to two opposite ends of the connecting section 921 and are resiliently foldable relative to the connecting section 921. The contacting section 93 is V-shaped and formed on one of the resilient sections 922. However, when the spring portion 92 of the terminal 90 is compressed, the resilient sections 922 pivots relative to the connecting section 921 such that the contacting portion 93 simultaneously retracts and sways left and right relative to the axial direction of the terminal 90. Therefore, the contacting portion 93 retracts along a curvedly or obliquely non-linear path and is easily jammed in the mounting hole 71. Furthermore, the V-shaped contacting portion 93 contacts an inner surface of the mounting hole 71 by point-contact instead of area-contact such that the inner surface of the mounting hole 71 cannot guide or assist the contacting portion 93 to move along a linear path, which further increases a probability of the contacting portion 93 obliquely deformed and jammed in the mounting hole 71. The deformed or jammed contacting portion 93 of the terminal 90 cannot stably contact the pad contact of the battery and therefore causes the defects or failure of power or signal transmission between the battery and the electronic device in which the connector is incorporated. Furthermore, the connecting section 921 is a straight section being parallel to an axial direction of the terminal 90 and cannot be compressed, which disadvantages the compressing performance of the terminal 90.

To overcome the shortcomings, the present invention provides an electrical connector with one-piece terminals to mitigate or obviate the aforementioned problems.

### SUMMARY OF THE INVENTION

The main objective of the invention is to provide an electrical connector that has multiple one-piece terminals. Each one-piece terminal has excellent resilience to provide stable extension and retraction functions. Furthermore, the one-piece terminal is capable of linearly extending or retracting instead of extending or retracting along a non-linearly and irregularly path, which prevents the one-piece terminal from being deformed or damaged.

An electrical connector in accordance with the present invention comprises an insulative body and multiple terminals. The insulative body has multiple mounting holes and multiple guiding channels. The terminals are mounted respectively the mounting holes and each terminal has an electrically contacting portion mounted slidably in one of the guiding channels. The guiding channels guides and ensures a corresponding electrically contacting portion to move linearly without being inadvertently jammed or irrecoverably deformed. Therefore, the life-span of the electrical connector is increased.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector with one-piece terminals in accordance with the present invention;

FIG. 2 is a front exploded perspective view of the electrical connector in FIG. 1;

FIG. 3 is a rear exploded perspective view of the electrical connector in FIG. 1;

FIG. 4 is a cross sectional top view of the electrical connector in FIG. 1;

FIG. 5 is a cross sectional side view of the electrical connector in FIG. 1;

FIG. 6 is an enlarged perspective view of a terminal of the electrical connector in FIG. 1; and

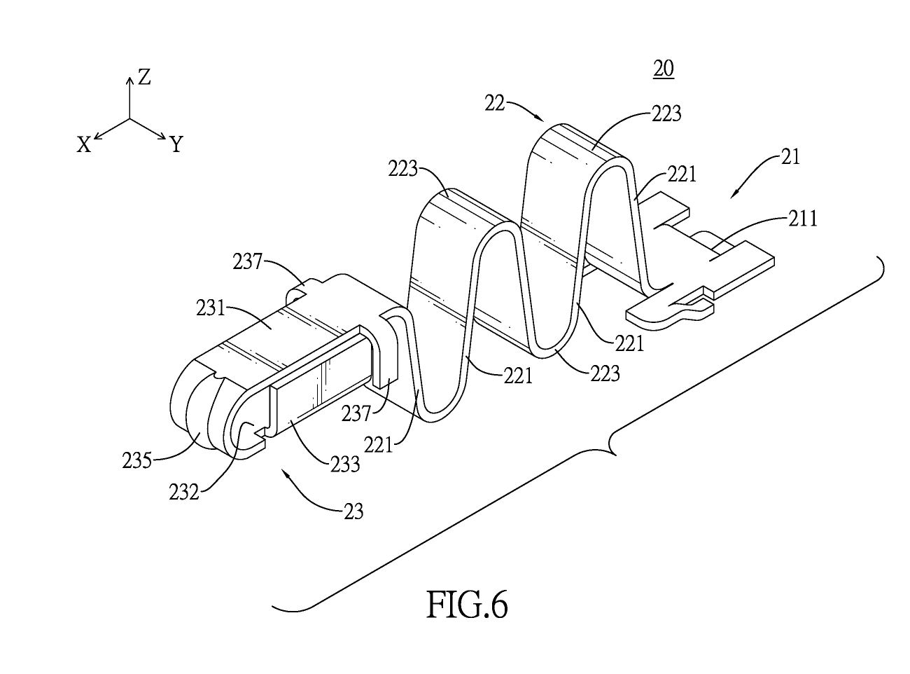

FIG. 7 is an exploded perspective view of a conventional connector with terminals in accordance with prior art.

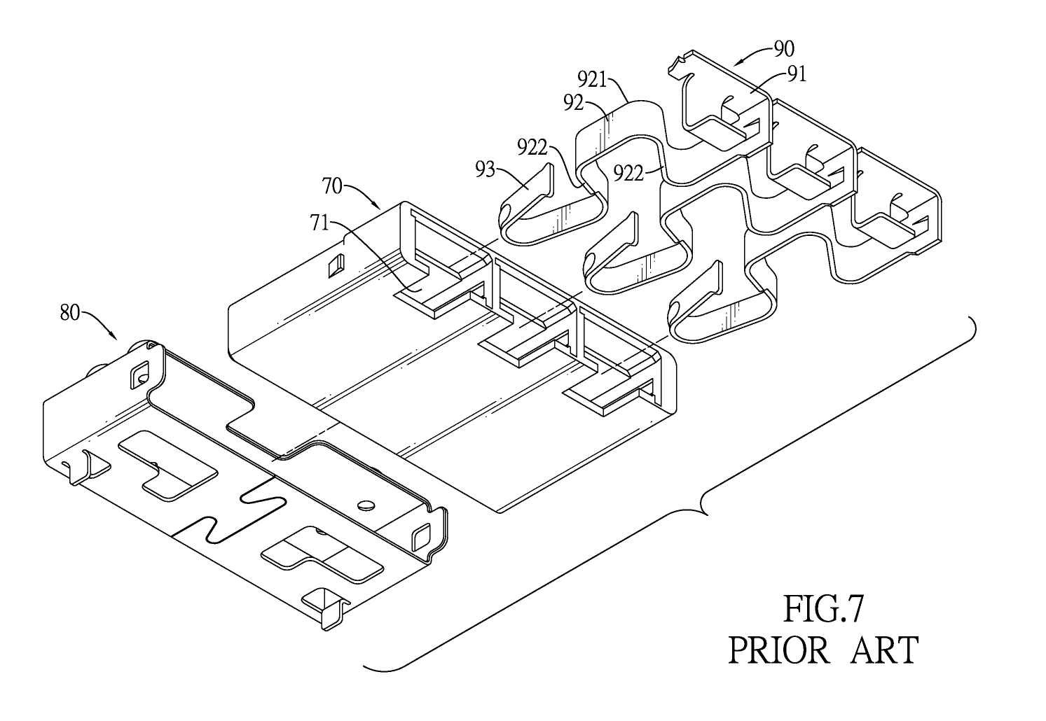

### DETAILED DESCRIPTION OF THE PREFERRED EMBODIMENT

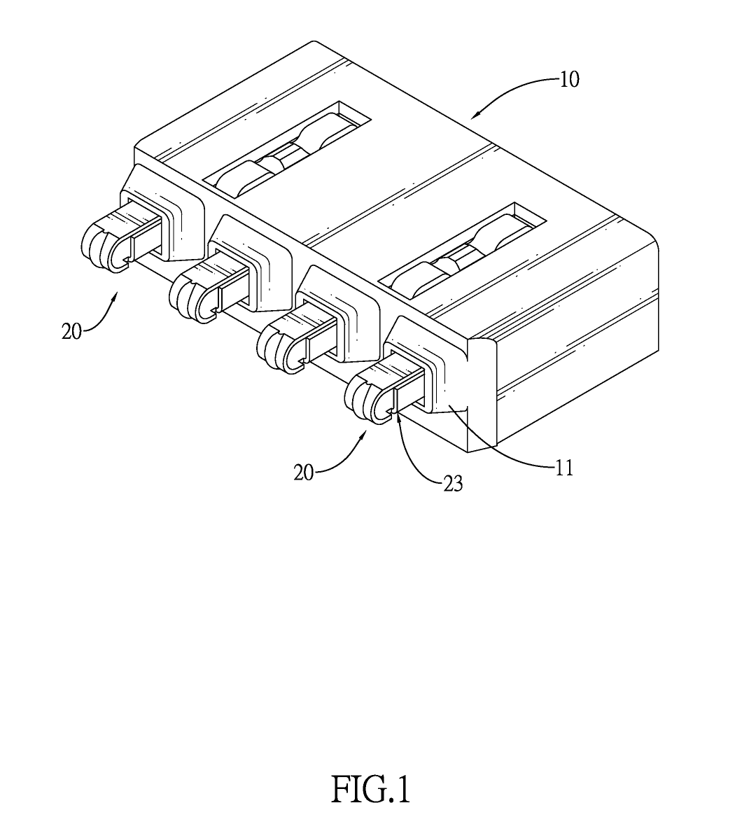

With reference to FIG. 1, an electrical connector in accordance with the present invention comprises an insulative body 10 and multiple terminals 20.

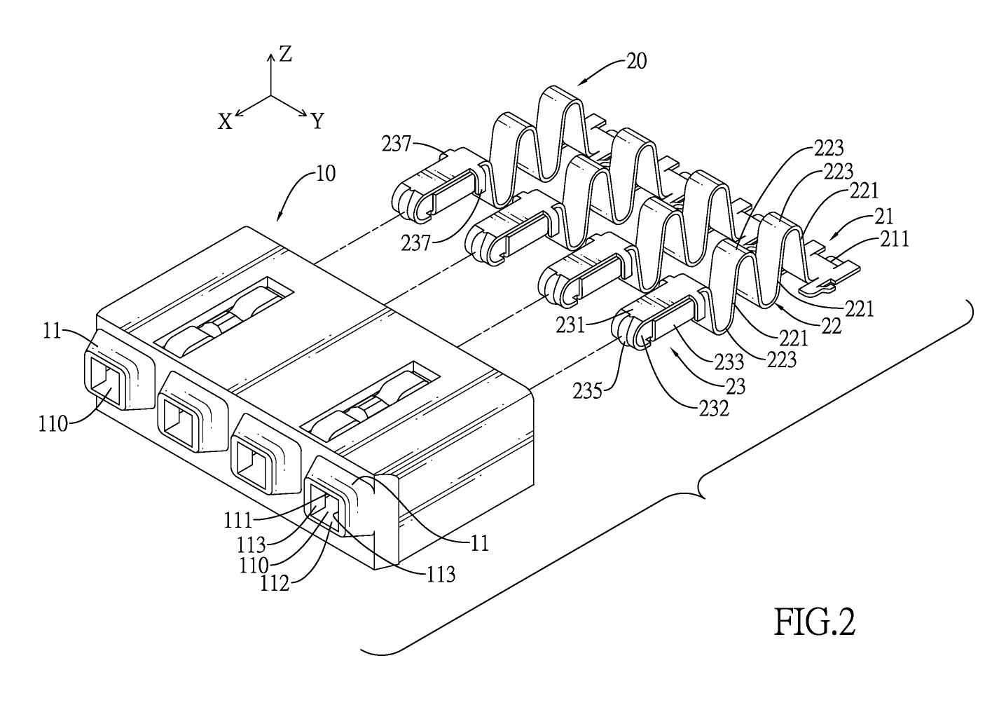

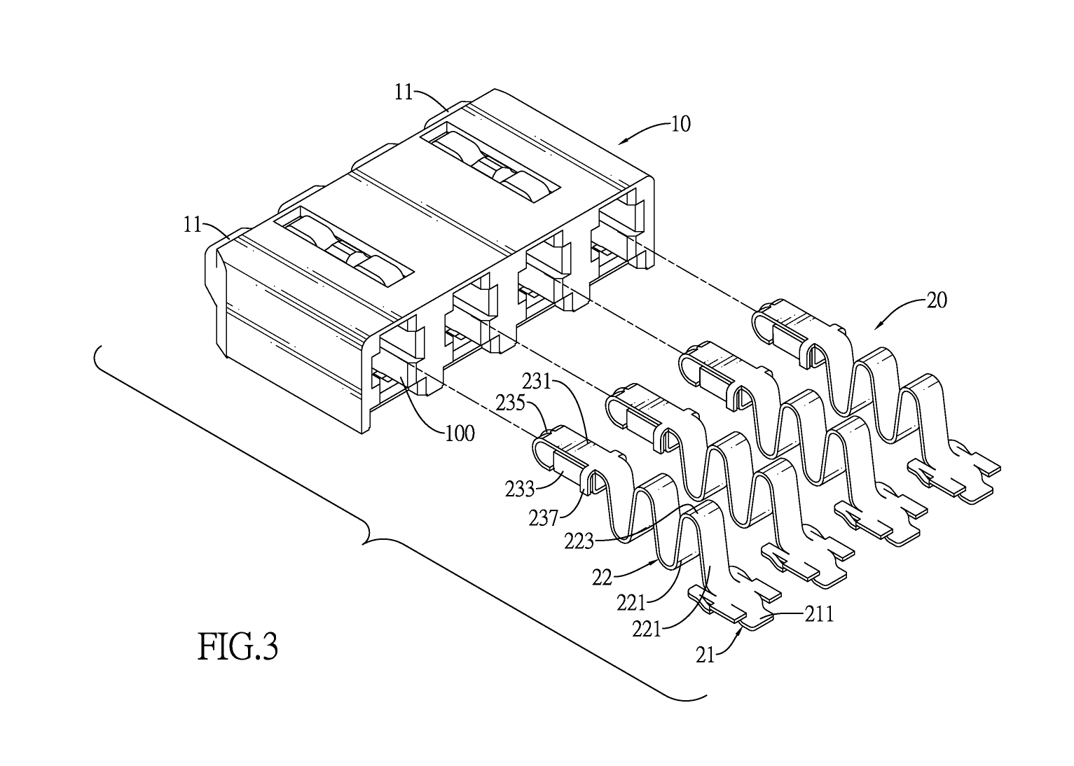

With further reference to FIGS. 2 and 3, the insulative body 10 has multiple mounting holes 100 and multiple guiding members 11. The mounting holes 100 are defined in the insulative body 10. The guiding members 11 are formed on a front end of the insulative body 10 and correspond to the mounting holes 100. Each guiding member 11 has a guiding channel 110. The guiding channel 110 is rectangular, is defined in the guiding member 11, communicates with a corresponding mounting hole 100 and has an inner surface. The inner surface may have an inner top surface 111, an inner bottom surface 112 and two opposite inner side surfaces 113 formed between the inner top surface 111 and the inner bottom surface 112.

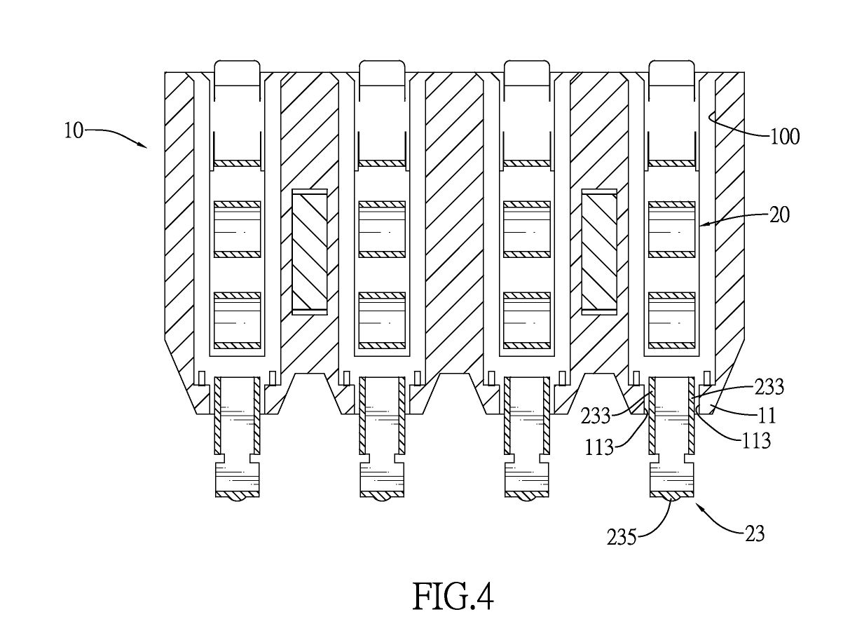

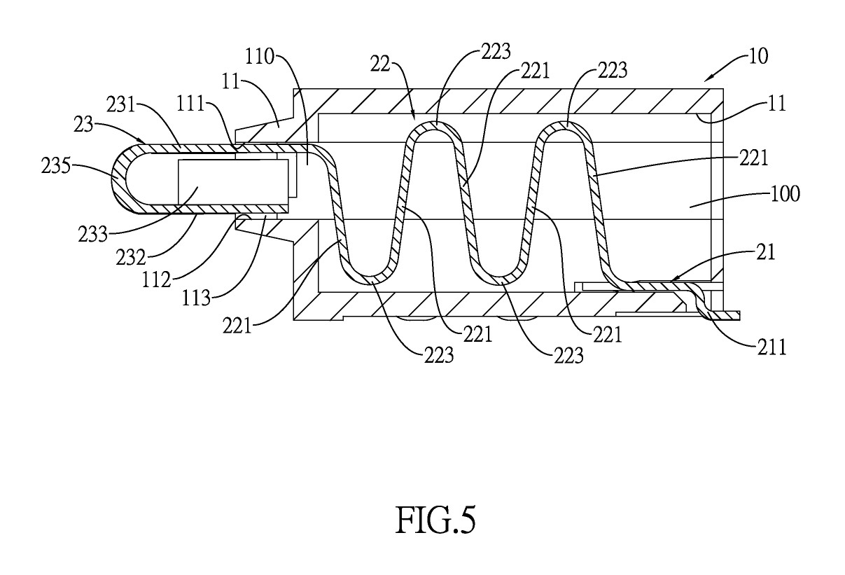

With further reference to FIGS. 4 and 5, the terminals 20 correspond to and are mounted respectively in the mounting holes 100 of the insulative body 10, and correspond to and are mounted the guiding channels 110 of the guiding members 11. Each terminal 20 is one-piece and has a soldering portion 21, a resilient portion 22 and an electrically contacting portion 23.

The soldering portion 21 has a soldering plate 211. The soldering plate 211 is folded and is formed on the soldering portion 21. The folded soldering plate 211 has a larger surface area in comparison to a conventional one to allow sufficient solder to adhere thereto such that the soldering performance is increased.

The resilient portion 22 is compressible and vertically wave-like, is formed on and protrudes forward from the soldering portion 21, is mounted in a corresponding mounting hole 100, and is constructed by multiple V-shaped portions connected in series. The resilient portion 22 has multiple resilient arms 221 and multiple connecting portions 223. The connecting portion 223 are curved and deformable, and are alternately formed between and connected to resilient arms 221 such that two adjacent resilient arms 221 and one connecting portion 223 form one V-shaped portion. Preferably, the resilient portion 22 zigzags along a plane constituted by a horizontal axis X and a vertical axis Z, as shown in FIG. 2.

The electrically contacting portion 23 is formed on and protrudes forward from the resilient portion 22, is mounted slidably in a corresponding guiding channel 110 of the guiding member 11 and contacts the inner surface of the corresponding guiding channel 110 by area-contact. The electrically contacting portion 23 may be rectangular and have a top surface 231, a bottom surface 232, two opposite side surfaces 233, two opposite embedding portions 237 and a convex contacting rib 235. The top surface 231 contacts the inner top surface 111 of the corresponding guiding channel 110. The bottom surface 232 contacts the inner bottom surface 112 of the corresponding guiding channel 110. The side surfaces are formed between the top surface 231 and the bottom surface 232 and respectively contact the inner side surfaces 113 of the corresponding guiding channel 110. The embedding portions 237 may be L-shaped and are formed on the electrically contacting portion 23 and are embedded in the insulative body 10. The convex contacting rib 235 is cat-pupil-like and is formed centrally on a front end of the electrically contacting portion 23 to improve electrically contacting performance.

When each terminal 20 retracts or extends, the electrically contacting portion 23 is guided by the corresponding guiding channel 110 and moves linearly along an axial direction of the terminal 20 that is parallel to the horizontal axis X.

The electrical connector has the following advantages.

1. Each terminal 20 is formed in one-piece to avoid problems of complicated structures and fabrication. Furthermore, the terminal 20 is formed integrally without multiple components to avoid problems of insufficient contacting areas between adjacent components. The integrally formed terminal 20 allows large current to pass through.

2. The electrically contacting portion 23 of each terminal 20 contacts the inner surface of the corresponding guiding channel 110 by area-contact instead of point contact such that the guiding channel 110 effectively guides the electrically contacting portion 23 to move linearly and prevents the electrically contacting portion 23 from being inadvertently jammed or irrecoverably deformed. Therefore, the terminals 20 may repetitively normally retract or extend to stably contact pad contacts of a battery mounted into the electrical connector, which improves the life span of the electrical connector.

3. Each terminal 20 has multiple V-shaped portions connected in series and each allows each V-shaped portion may be compressed for a stroke such that a total compression stroke of the V-shaped portions of each terminal is larger than that of a conventional terminal and provides higher resilient force to ensures stable electrical contact between the terminal 20 and the pad contact of the battery.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An electrical connector comprising:
an insulative body having
multiple mounting holes defined in the insulative body; and
multiple guiding members formed on a front end of the insulative body and correspond to the mounting holes, and each guiding member having a guiding channel defined in the guiding member, communicating with a corresponding mounting hole and having an inner surface; and
multiple terminals corresponding to and mounted respectively in the mounting holes of the insulative body, corresponding to and mounted the guiding channels of the guiding members, and each terminal being one-piece and having
a soldering portion;
a resilient portion being compressible and vertically wave-like, formed on and protruding forward from the soldering portion and mounted in a corresponding mounting hole; and
an electrically contacting portion formed on and protruding forward from the resilient portion, mounted slidably in a corresponding guiding channel of the guiding member and contacting the inner surface of the corresponding guiding channel by area-contact;
wherein when each terminal retracts or extends, the electrically contacting portion is guided by the corresponding guiding channel and moves linearly along an axial direction of the terminal.

2. The electrical connector as claimed in claim 1, wherein
each guiding channel is rectangular and the inner surface of the guiding channel has an inner top surface, an inner bottom surface and two opposite inner side surfaces formed between the inner top surface and the inner bottom surface; and
the electrically contacting portion of each terminal is rectangular and has
a top surface contacting the inner top surface of the corresponding guiding channel;
a bottom surface contacting the inner bottom surface of the corresponding guiding channel; and
two opposite side surfaces formed between the top surface and the bottom surface and respectively contacting the inner side surfaces of the corresponding guiding channel.

3. The electrical connector as claimed in claim 2, wherein the resilient portion of each terminal is constructed by multiple V-shaped portions connected in series and has
multiple resilient arms being; and
multiple connecting portions alternately formed between and connected to resilient arms such that two adjacent resilient arms and one connecting portion form one V-shaped portion.

4. The electrical connector as claimed in claim 3, wherein each connecting portion is curved and deformable.

5. The electrical connector as claimed in claim 4, wherein the resilient portion of each terminal zigzags along a plane constituted by a horizontal axis and a vertical axis.

6. The electrical connector as claimed in claim 5, wherein the electrically contacting portion of each terminal further has two opposite embedding portions formed on the electrically contacting portion and embedded in the insulative body.

7. The electrical connector as claimed in claim 6, wherein each embedding portion is L-shaped.

8. The electrical connector as claimed in claim 7, wherein the soldering portion of each terminal has a soldering plate folded and is formed on the soldering portion.

9. The electrical connector as claimed in claim 8, wherein the electrically contacting portion of each terminal further has a convex contacting rib formed centrally on a front end of the electrically contacting portion.
